(19) United States
(12) Patent Application Publication
(10) Pub. No.: US 2017/0015125 A1
(43) Pub. Date: Jan. 19, 2017

(54) EJECTION DEVICE

(71) Applicant: Funai Electric Co., Ltd., Osaka (JP)

(72) Inventor: Koichi Kobayashi, Osaka (JP)

(73) Assignee: Funai Electric Co., Ltd., Osaka (JP)

(21) Appl. No.: 15/211,848

(22) Filed: Jul. 15, 2016

(30) Foreign Application Priority Data
Jul. 16, 2015 (JP) 2015-142024
Jun. 27, 2016 (JP) 2016-126374

(51) Int. Cl. B41J 29/393

(52) U.S. Cl. CPC B41J 29/393

(57) ABSTRACT

An ejection device includes a discharger that discharges liquid droplets on an object while moving in at least a first direction, a camera that images the object, and a camera protector that covers a light receiving surface of the camera when the discharger discharges the liquid droplets.

### TECHNICAL FIELD

The present invention relates generally to an ejection device.

A printer is known that discharges ink onto a target object with a three-dimensional shape by moving a print head in a predetermined scan direction, thereby printing onto the surface thereof.

Patent document 1 discloses a nail printer that prints on the nail part of a finger. The patent document refers to a configuration wherein the tip of a finger is placed against a finger contacting part, causing the tip of the nail to protrude beyond the tip of the finger, and printing is performed up to the area outside the contour of the nail for a contoured part of the nail protruding beyond the finger, thereby preventing the fingertip from becoming dirty due to ink scattered in a mist form.

### DOCUMENTS OF THE PRIOR ART

### Patent Documents

[Patent Document 1] Japanese Unexamined Patent Application Publication No. 2014-124230

### SUMMARY OF THE INVENTION

In a printer that prints on a target object with a three-dimensional shape, such as a nail printer, a camera unit is provided to image the position and shape of the target object. In the invention in patent document 1, ink scattered in a mist form can be prevented from adhering to the fingertip, but no consideration has been given to a configuration preventing ink from adhering to a light receiving surface of the camera unit. For this reason, the performance of the camera unit degrades as ink adheres to the light receiving surface of the camera unit, and it is possible for it to become no longer able to accurately recognize position, curvature, and the like for the nail part.

Consequently, a technique is sought that can prevent liquid droplets such as ink from adhering to a light receiving surface of a camera unit in an ejection device with a camera unit.

One or more embodiments of the invention provide an ejection device that can prevent liquid droplets from adhering to the light receiving surface of a camera unit.

In one or more embodiments of the invention, an ejection device comprises a discharger that discharges liquid droplets on an object while moving in at least a first direction, a camera that images the object, and a camera protector that covers a light receiving surface of the camera when the discharger discharges the liquid droplets.

According to one or more embodiments of the invention, an ejection device can prevent liquid droplets from adhering to a light receiving surface of a camera unit.

### BRIEF DESCRIPTION OF THE DRAWINGS

FIG. 1 shows a perspective view illustrating a configuration of a printer according to one or more embodiments of the present invention.

FIG. 2 shows a planar view illustrating a configuration of a printer according to one or more embodiments of the present invention.

FIG. 3 shows a profile view illustrating a configuration of a printer according to one or more embodiments of the present invention.

FIG. 4 shows a planar view for describing a movement range of a print head according to one or more embodiments of the present invention.

FIG. 5 shows a front view of a print head in a printing position according to one or more embodiments.

FIG. 6 shows a front view of a print head in an imaging position according to one or more embodiments of the present invention.

FIG. 7 shows a front view of a print head in a printing position according to one or more embodiments of the present invention.

FIG. 8 shows a front view of a print head in an imaging position according to one or more embodiments of the present invention.

FIG. 9 shows a perspective view illustrating a configuration of a print head according to one or more embodiments of the present invention.

FIG. 10 shows a planar view of a print head in a printing position according to one or more embodiments of the present invention.

FIG. 11 shows a planar view of a print head in an imaging position according to one or more embodiments of the present invention.

FIG. 12 shows a front view of a print head in an imaging position according to one or more embodiments of the present invention.

FIG. 13 shows a perspective view illustrating a configuration of an overhang part and an obstructing part according to one or more embodiments of the present invention.

FIG. 14 shows a profile view illustrating a configuration of an overhang part and an obstructing part according to one or more embodiments of the present invention.

FIG. 15 shows a frontal cross-sectional view illustrating a configuration of an overhang part and an obstructing part according to one or more embodiments of the present invention.

FIG. 16 shows a front view of a print head in a printing position according to one or more embodiments of the present invention.

FIG. 17 shows a profile view illustrating a configuration of a print head according to one or more embodiments of the present invention.

FIG. 18 shows a planar view of a print head in a printing position according to one or more embodiments of the present invention.

FIG. 19 shows a planar view of a print head in an imaging position according to one or more embodiments of the present invention.

FIG. 20 shows a planar view of a print head in a printing position according to one or more embodiments of the present invention.

FIG. 21 shows a planar view of a print head in an imaging position according to one or more embodiments of the present invention.

FIG. 22 shows an exploded perspective drawing illustrating a camera protection part according to one or more embodiments of the present invention.

FIG. 23 shows a profile view illustrating a camera protection part according to one or more embodiments of the present invention.

FIG. 24 shows a planar view of a print head in a printing start position according to one or more embodiments of the present invention.

FIG. 25 shows a planar view of a print head in a printing finish position according to one or more embodiments of the present invention.

FIG. 26 shows a planar view of a print head in an imaging position according to one or more embodiments of the present invention.

FIG. 27 shows a perspective view illustrating a configuration of a printer according to one or more embodiments of the present invention.

FIG. 28 shows a planar view illustrating a configuration of a printer according to one or more embodiments of the present invention.

FIG. 29 shows a profile view illustrating a configuration of a printer according to one or more embodiments of the present invention.

FIG. 30 shows a planar view for describing the movement range of a print head according to one or more embodiments of the present invention.

FIG. 31 shows a front view of a print head in a printing position according to one or more embodiments of the present invention.

FIG. 32 shows a front view of a print head in an imaging position according to one or more embodiments of the present invention.

### DETAILED DESCRIPTION OF THE INVENTION

Embodiments of the present invention are described hereinafter based on drawings. The following description of the embodiments is intrinsically nothing more than an example, and is not intended to limit the present invention, its application, or use thereof.

### Example 1

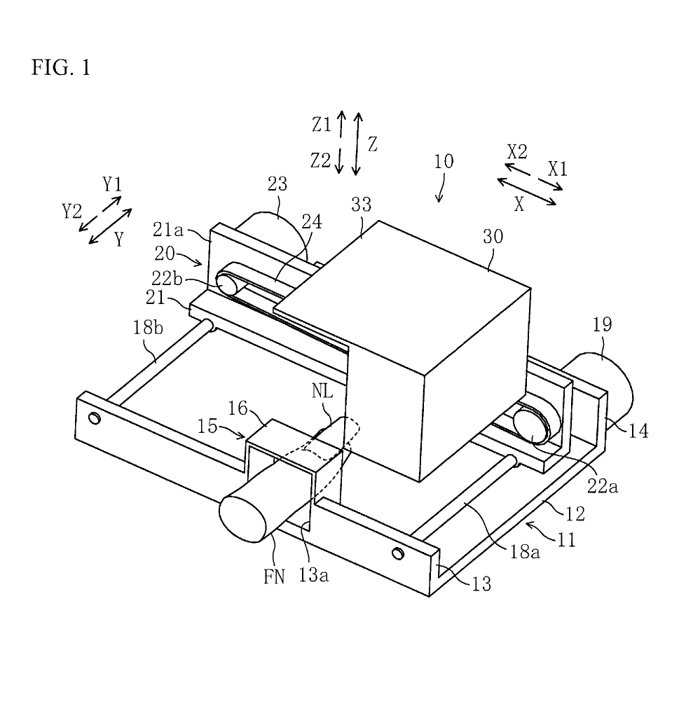

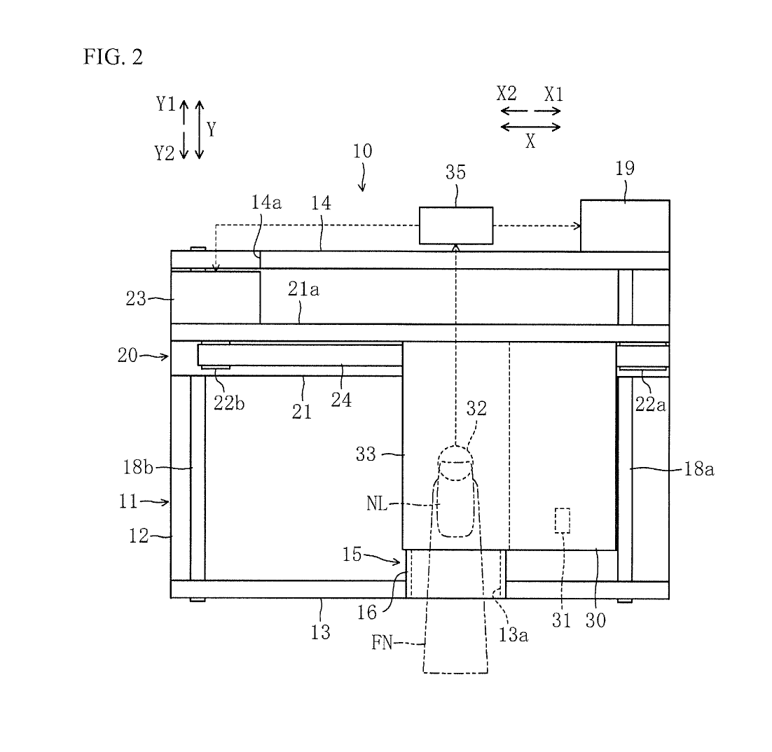

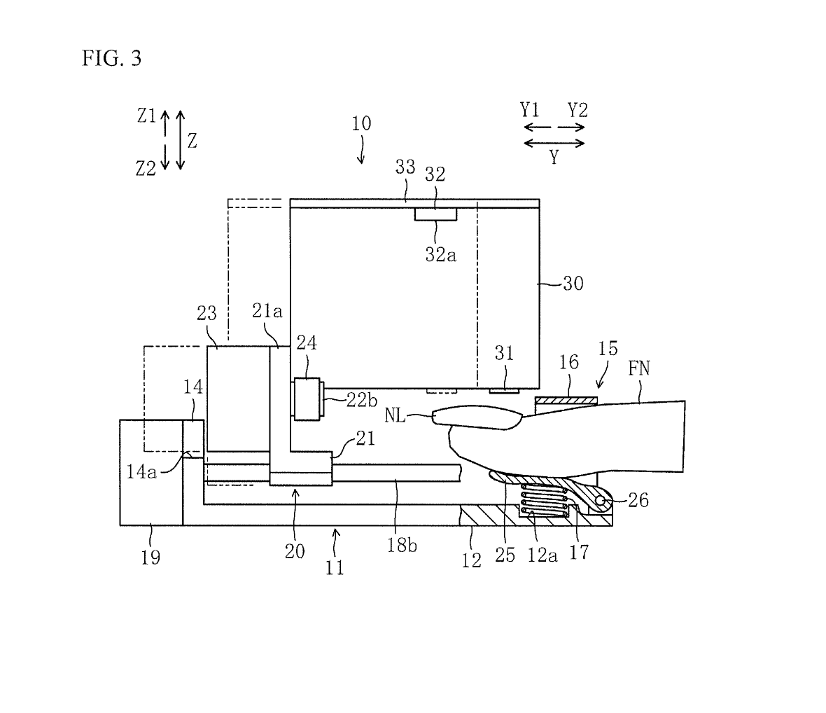

First, an example will be described where the ejection device in accordance with one or more embodiments of the present invention is a nail printer 10 that can print any color or pattern on a fingernail. As illustrated in FIG. 1 through FIG. 3, the printer 10 comprises a chassis part 11 (chassis) with a finger fixing mechanism 15 that fixes the nail part NL of a finger FN in a predetermined position as a printing body (target object) and a scanning part 20 with a print head 30 that prints on the nail part NL of the finger FN that has been fixed in the predetermined position.

In the present example, the width direction of the finger FN when the finger FN has been fixed in the finger fixing mechanism 15 is called the X direction, the direction that the finger FN extends is called the Y direction, and the direction of the height of the finger FN is called the Z direction. In each drawing, the X direction, the Y direction, and the Z direction are indicated with arrows. In the present example, the X direction is the first direction. The Y direction is the second direction.

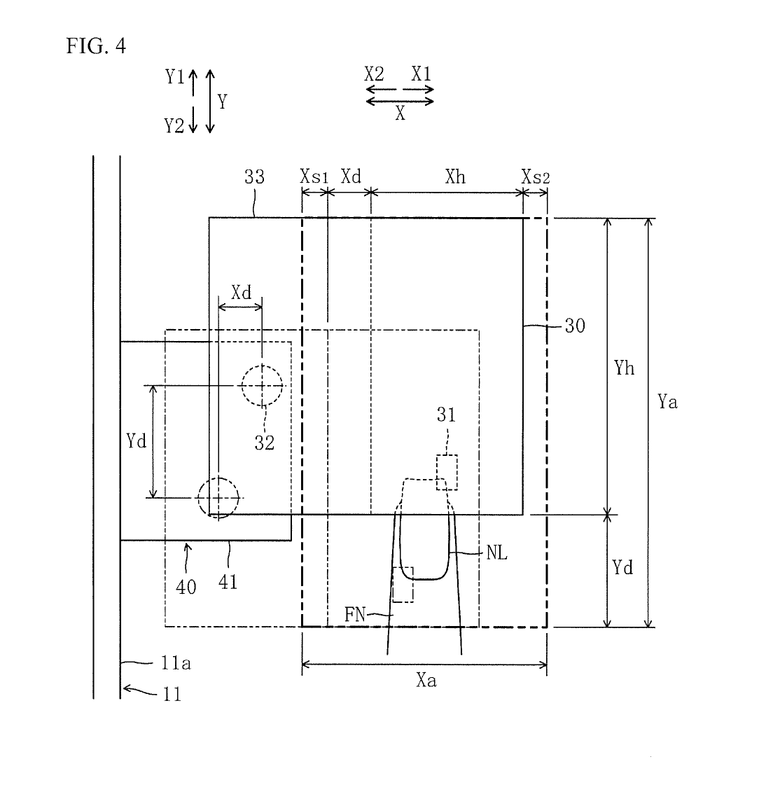

The chassis part 11 has a base plate 12, a first side wall 13 provided upright from the edge on the Y2 side of the base plate 12, and a second side wall 14 provided upright from the edge on the Y1 side of the base plate 12. Also, the chassis part 11 has a chassis frame 11a disposed on both sides of the print head 30 in the X direction, so that the print head 30 is contained therein (see FIG. 4).

An open section 13a through which the finger FN can be inserted is formed in an approximately central position in the X direction in the first side wall 13 by cutting out a portion thereof. The finger fixing mechanism 15 has a gate-shaped fixed frame 16 provided so as to surround the open section 13a, a bias spring 17 disposed on the base plate 12, a finger placement plate 25 disposed to the Z1 side of the bias spring 17, and a support shaft 26 extending in the X direction and supporting the edge part of the Y2 side of the finger placement plate 25 so that it can rotate.

The bias spring 17 is set within a depression 12a formed in the base plate 12 with the edge part to the Z1 side protruding from the depression 12a, biasing toward the Z1 side of the finger placement plate 25. Here, when the finger FN is inserted through the open section 13a and placed on the finger placement plate 25, the finger placement plate 25 is lifted up by the biasing force of the bias spring 17, and the finger FN is biased to the Z1 side. A state is hereby brought about wherein the finger FN is interposed between the fixed frame 16 and the finger placement plate 25, fixing the finger FN in a predetermined position.

The chassis part 11 comprises two Y axis motor shafts 18a, 18b provided in parallel with a gap there between in the X direction that extend between the first side wall 13 and the second side wall 14. The Y axis motor shaft 18a to the X1 side is attached to a Y axis motor 19. A cutout portion 14a to avoid interference with an X axis motor 23, described hereinafter, is formed in the upper portion to the X2 side of the second side wall 14.

The scanning part 20 has a scanning table 21 supported so that it is movable in the Y direction along the Y axis motor shafts 18a, 18b and a print head 30 provided on the scanning table 21.

The scanning table 21 is composed of a plate shaped body having an L shaped cross section with a wall part 21a provided upright from the edge of the Y1 side thereof. A pair of pulleys 22a, 22b are disposed on the wall part 21a of the scanning table 21, with a gap there between in the X direction. The pulley 22a on the X1 side is supported so that it can rotate around an axis in the Y direction orthogonal to the wall part 21a. The pulley 22b on the X2 side is connected to the X axis motor 23. The pair of pulleys 22a, 22b are wrapped about by an endless X axis motor belt 24. The print head 30 is attached to the X axis motor belt 24.

Here, by driving the X axis motor 23, rotational force from the X axis motor 23 is transmitted to the X axis motor belt 24 via the pulleys 22a, 22b, moving the print head 30 in the X direction according to the amount of rotation of the X axis motor belt 24. Also, by driving the Y axis motor 19, rotational force from the Y axis motor 19 is transmitted to the Y axis motor shaft 18a, causing the print head 30 to move in the Y direction along with the scanning table 21.

Thus, by driving the X axis motor 23 and the Y axis motor 19, the print head 30 can be caused to move in a predetermined scanning direction (X direction and Y direction).

The print head 30 has a nozzle part 31 (an example of discharger) for discharging ink (liquid droplets) on the nail part NL and a camera unit 32 (camera) for imaging the nail part NL. The print head 30 comprises a camera attachment part 33 (camera attachment) overhanging from the edge part of the Z1 side toward the X2 side.

The camera unit 32 is attached to the surface of the Z2 side of the camera attachment part 33, and is disposed further than the nozzle part 31 to the X2 side and to the Y1 side. By causing the print head 30 to move in the X direction and the Y direction, it is possible to switch between a printing position for printing, wherein the nozzle part 31 is facing the nail part NL, and an imaging position for imaging, wherein the light receiving surface 32a of the camera unit 32 is facing the nail part NL. An image captured by the camera unit 32 is input to a controller 35.

In the controller 35, for example, a region of the nail part NL, that is, a region in which printing will be performed, is identified based on the captured image. The controller 35 also controls the operation of the print head 30 so as to print a predetermined nail design on the nail part NL.

In particular, the controller 35 causes the print head 30 to move in a printing region on the nail part NL by controlling the driving of the X axis motor 23 and the Y axis motor 19. The print head 30 moves rapidly in the X direction and performs step feed in the Y direction. Also, the controller 35 causes ink to impact the nail part NL by controlling the discharge of ink from the nozzle part 31.

Incidentally, when moving the print head 30 to a printing position and printing on the nail part NL of the finger FN by discharging ink from the nozzle part 31, ink is scattered in a mist form. There is a risk that the performance of the camera unit 32 will degrade as ink scattered in a mist form adheres to the light receiving surface 32a of the camera unit 32, as the camera unit 32 is disposed on the X2 side of the nozzle part 31.

Thus, in the present example, the configuration is such that a camera protection part 40 (camera protector) is provided to prevent ink scattered in a mist form from adhering to the light receiving surface 32a of the camera unit 32.

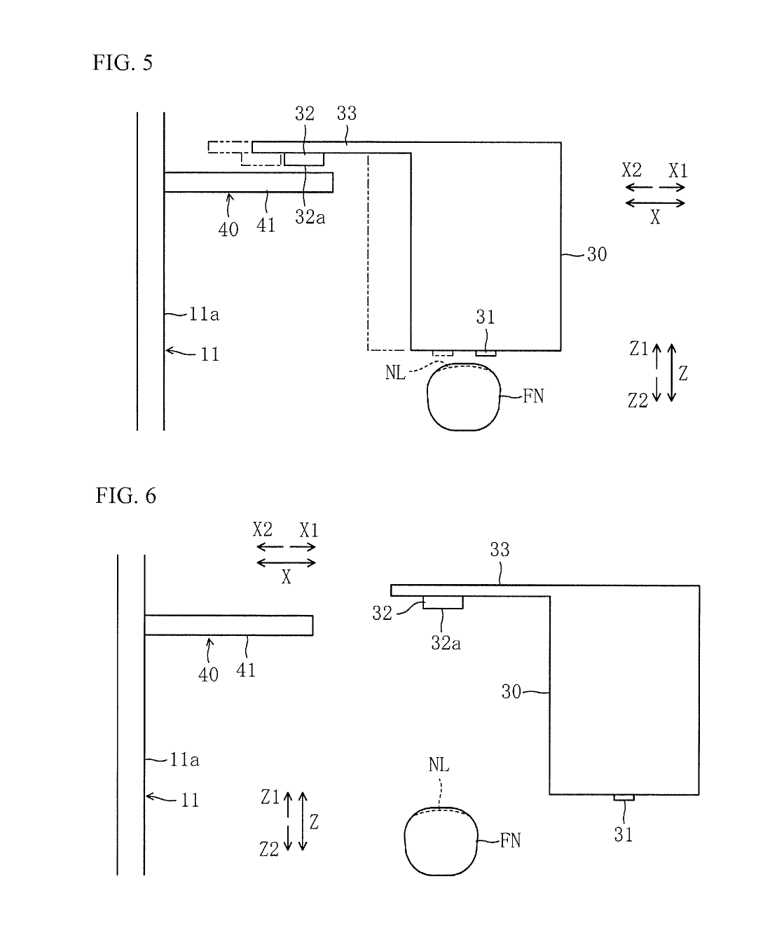

In particular, as illustrated in FIG. 4 and FIG. 5, the chassis frame 11a of the chassis part 11 is provided further to the X2 side than the print head 30. The chassis frame 11a has provided an overhang part 41 (overhang) overhanging from the side wall on the X2 side toward the X1 side. The overhang part 41 protrudes to a position that covers the light receiving surface 32a of the camera unit 32 on the print head 30 in a printing position. Thus, in the present example, the camera protection part 40 is composed of the overhang part 41.

Here, in order to avoid interference with the print head 30, the overhang part 41 is disposed outside the movement range of the print head 30. In particular, the movement range of the print head 30 is a range set as Xₐ×Yₐ, where Xₐ is the length in the X direction and Yₐ is the length in the Y direction (the region enclosed in an imaginary line in FIG. 4).

The length in the X direction Xₐ is calculated using the sum of the length of the print head 30 in the X direction Xₕ, the stroke of the acceleration/deceleration area of the print head 30 in the X direction Xs1, Xs2, and the movement distance X_{d} in which the print head 30 moves in the X direction when printing on the nail part NL.

The stroke of the acceleration/deceleration area Xs1, Xs2 is the distance necessary for the print head 30 moving rapidly in the X direction to reach a constant speed. The movement distance Xd of the print head 30 in the X direction is the distance for when the nozzle part 31 of the print head 30, indicated with a solid line in FIG. 4, moves to the position of the nozzle part 31 indicated with an imaginary line in FIG. 4.

In particular, the edge part to the X1 side and Y1 side of the nail part NL is the printing start position for the print head 30, and the edge part to the X2 side and Y2 side of the nail part NL is the printing finish position for the print head 30. When printing on the nail part NL, the print head 30 moves from the printing start position to the printing finish position which thereby determines the movement distance X_{d} of the print head 30 in the X direction.

The length in the Y direction Yₐ is calculated using the sum of the length of the print head 30 in the Y direction Yₕ and the movement distance Y_{d} in which the print head 30 moves in the Y direction when printing on the nail part NL. The print head 30 does not move rapidly in the Y direction. Thus, in the Y direction, the stroke of the acceleration/deceleration area is not considered.

The movement distance Yd of the print head 30 in the Y direction is the distance for when the nozzle part 31 of the print head 30, indicated with a solid line in FIG. 4, moves to the position of the nozzle part 31 indicated with an imaginary line in FIG. 4. When printing on the nail part NL, the print head 30 moves from the printing start position to the printing finish position which thereby determines the movement distance Y_{d} of the print head 30 in the Y direction.

The overhang part 41 is set at a size at which it is possible for it to always cover the camera unit 32 while the print head 30 discharges ink as it moves from the printing start position to the printing finish position in the X direction and the Y direction. In particular, because the camera unit 32 moves only a distance X_{d} in the X direction with the print head 30, and moves only a distance Y_{d} in the Y direction, it is set at a size at which it is possible to cover at least this movement range. For example, the overhang part 41 has at least an area represented by the product of X_{d} and Y_{d}.

When the print head 30 is in a printing position, the camera unit 32 and the overhang part 41 overlap in a planar view, and the light receiving surface 32a of the camera unit 32 is covered by the overhang part 41. Thus ink scattered in a mist form can be prevented from adhering to the light receiving surface 32a of the camera unit 32.

Meanwhile, as illustrated in FIG. 6, when the print head 30 is in an imaging position, the camera unit 32 and the overhang part 41 do not overlap in a planar view, and the light receiving surface 32a of the camera unit 32 is exposed. Thus it is possible to image the nail part NL using the camera unit 32.

Using a configuration of this sort, by simply moving the print head 30 between an imaging position and a printing position, it is possible to expose the light receiving surface 32a of the camera unit 32 when in an imaging position, making imaging of the nail part NL possible, as well as to cover the light receiving surface 32a of the camera unit 32 when in a printing position with overhang part 41, protecting the camera unit 32.

### Example 2

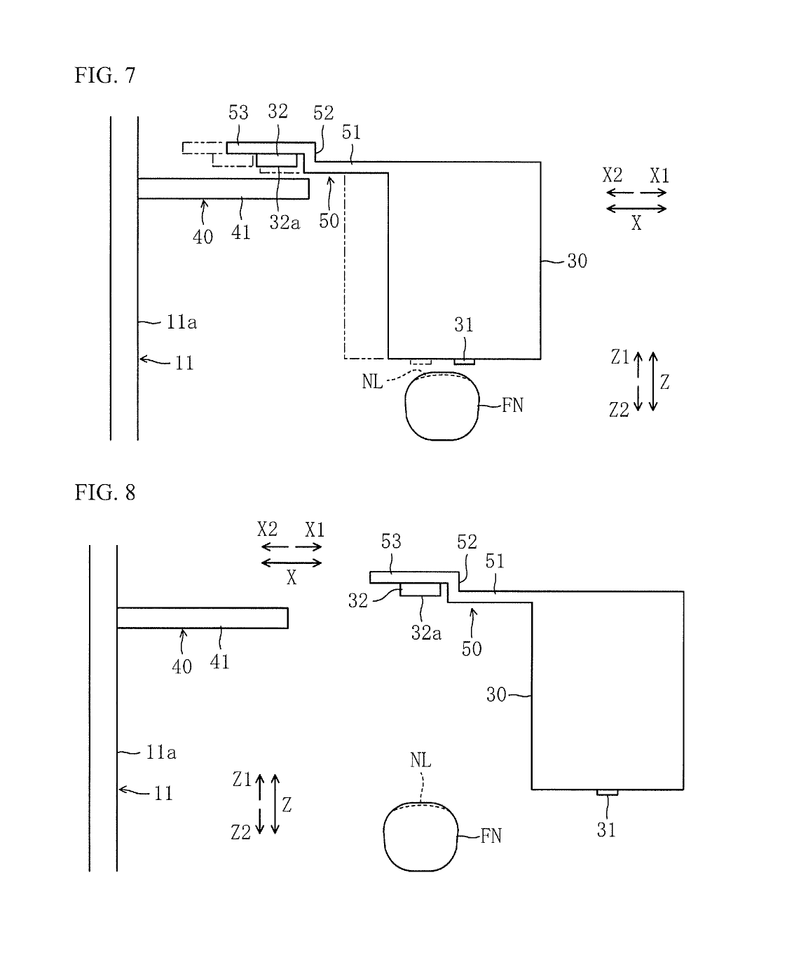

FIG. 7 is a front view drawing when a print head according to one or more embodiments of the present invention is in a printing position. Below the same reference numerals will be added for the same parts as the aforementioned example 1, and only the points of difference will be described.

As illustrated in FIG. 7, the chassis frame 11a of the chassis 11 is provided further to the X2 side than the print head 30. The chassis frame 11a has provided an overhang part 41 overhanging from the side wall on the X2 side toward the X1 side. The overhang part 41 protrudes to a position that covers the light receiving surface 32a of the camera unit 32 on the print head 30 in a printing position; the camera protection part 40 is composed of the overhang part 41.

The print head 30 comprises an extending section 51 overhanging from the edge part to the Z1 side to the X2 side, a stepped part 52 extending from the edge part to the X2 side of the extending section 51 to the Z1 side, and a camera attachment part 53 extending from the edge part to the Z1 side of the stepped part 52 to X2 side.

The camera unit 32 is attached on the surface on the Z2 side of the camera attachment part 53. The surface on the Z2 side of the extending section 51 is positioned more to the Z2 side than the light receiving surface 32a of the camera unit 32, and more to the Z1 side than the surface on the Z1 side of the overhang part 41. Further, the edge part to the X2 side of the extending section 51 overlaps with the overhang part 41 in a planar view when the print head 30 is in a printing position. Thus an obstructing part 50 is formed by the extending section 51 blocking the gap between the print head 30 and the overhang part 41.

When the print head 30 is in a printing position, the camera unit 32 and the overhang part 41 overlap in a planar view, and the light receiving surface 32a of the camera unit 32 is covered by the overhang part 41. At this time, because the gap between the print head 30 and the overhang part 41 is blocked by the extending section 51, ink scattered in a mist form can be prevented from entering through the gap and adhering to the light receiving surface 32a of the camera unit 32.

Meanwhile, as illustrated in FIG. 8, when the print head 30 is in an imaging position, the camera unit 32 and the overhang part 41 do not overlap in a planar view, and the light receiving surface 32a of the camera unit 32 is exposed. Thus it is possible to image the nail part NL using the camera unit 32.

### Example 3

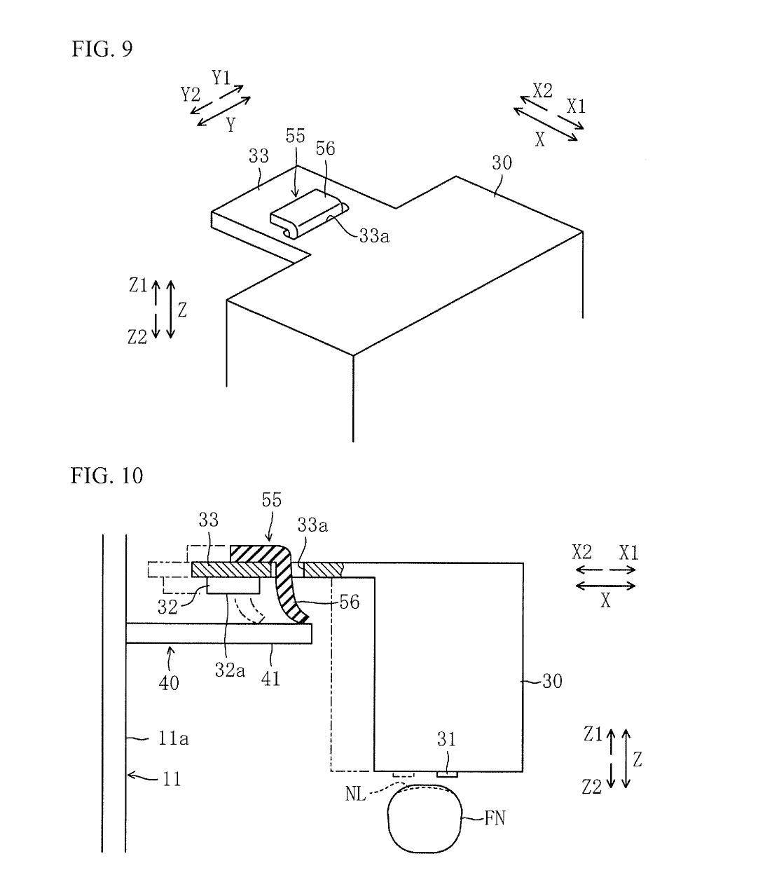

FIG. 9 is a perspective drawing of a configuration of a print head according to one or more embodiments of the present invention, and FIG. 10 is a front view drawing when a print head is in a printing position. Below the same reference numerals will be added for the same parts as the aforementioned example 1, and only the points of difference will be described.

As illustrated in FIG. 9 and FIG. 10, the print head 30 has provided a camera attachment part 33 overhanging from the edge part on the Z1 side toward the X2 side. A through-hole 33a passing through in the Z direction is formed in the camera attachment part 33. An elastic member 56 that can deform elastically is fitted in the through-hole 33a. The elastic member 56 is formed of rubber or the like.

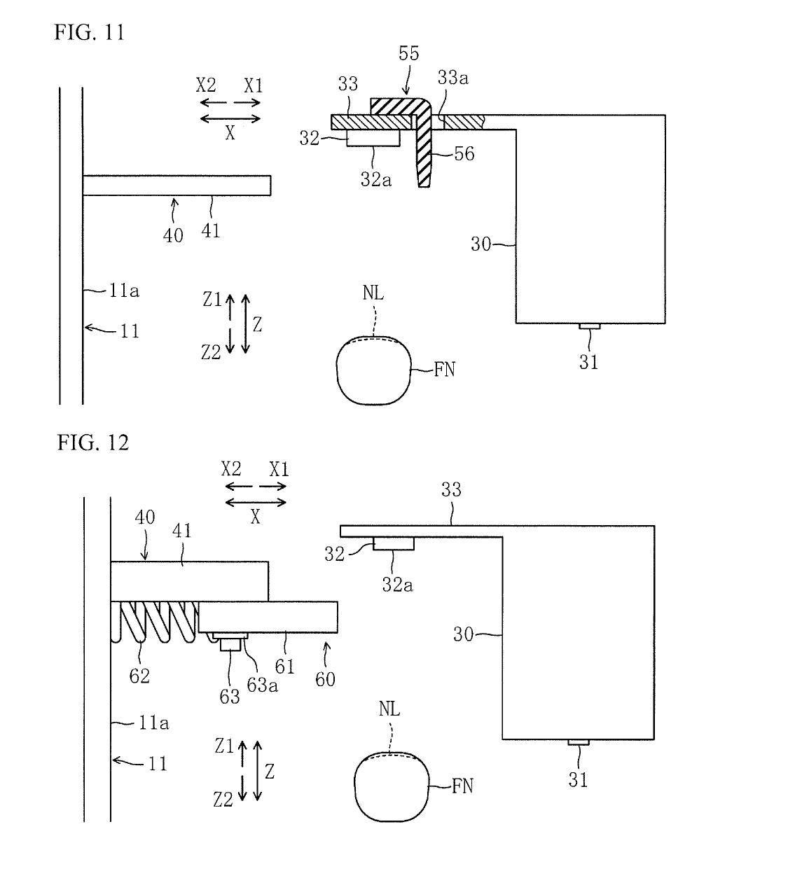

The edge part to the Z2 side of the elastic member 56 stretches further to the Z2 side than the surface to the Z1 side of the overhang part 41 (see FIG. 11). Meanwhile, as illustrated in FIG. 10, when the print head 30 is in a printing position, the elastic member 56 comes into contact with the overhang part 41 and elastically deforms, causing the edge part to the Z2 side of the elastic member 56 to cohere to the surface to the Z1 side of the overhang part 41. Thus an obstructing part 55 is formed by the elastic member 56 blocking the gap between the print head 30 and the overhang part 41.

When the print head 30 is in a printing position, the camera unit 32 and the overhang part 41 overlap in a planar view, and the light receiving surface 32a of the camera unit 32 is covered by the overhang part 41. At this time, because the gap between the print head 30 and the overhang part 41 is blocked by the elastic member 56, ink scattered in a mist form can be prevented from entering through the gap and adhering to the light receiving surface 32a of the camera unit 32.

Meanwhile, as illustrated in FIG. 11, when the print head 30 is in an imaging position, the camera unit 32 and the overhang part 41 do not overlap in a planar view, and the light receiving surface 32a of the camera unit 32 is exposed. Thus it is possible to image the nail part NL using the camera unit 32.

### Example 4

FIG. 12 is a front view drawing when a print head according to one or more embodiments of the present invention is in a printing position. Below the same reference numerals will be added for the same parts as the aforementioned example 1, and only the points of difference will be described.

As illustrated in FIG. 12, the chassis frame 11a of the chassis part 11 is provided further to the X2 side than the print head 30. The chassis frame 11a has provided an overhang part 41 overhanging from the side wall on the X2 side toward the X1 side. The overhang part 41 protrudes to a position that covers the light receiving surface 32a of the camera unit 32 on the print head 30 in a printing position, and so the camera protection part 40 is composed of the overhang part 41.

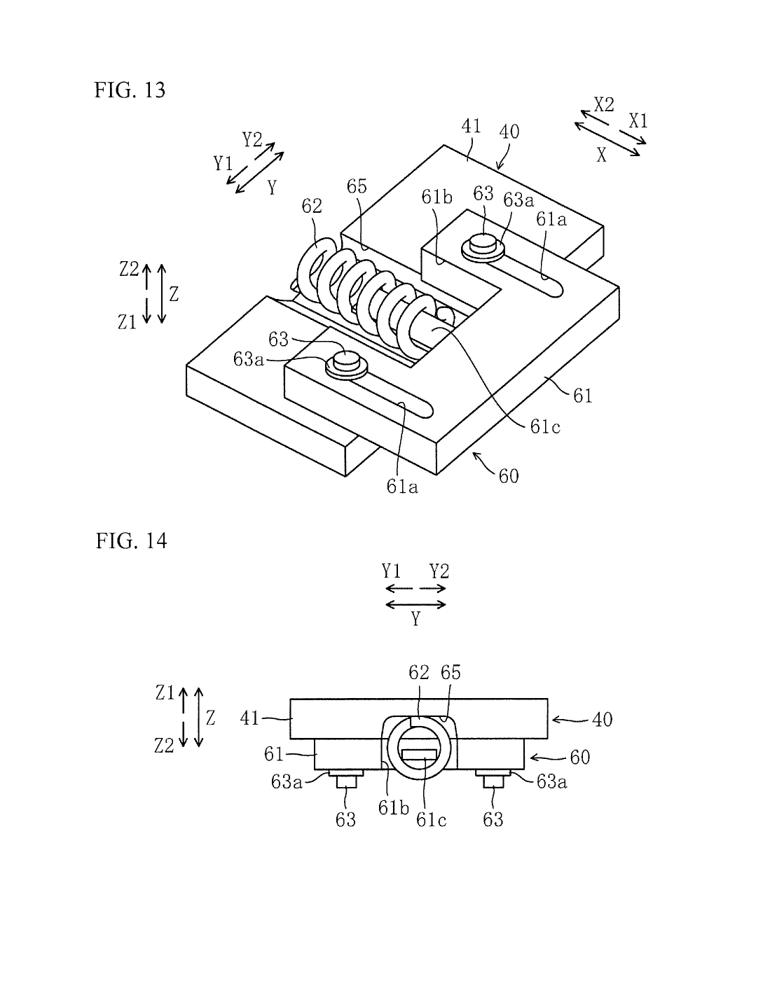

As illustrated in FIG. 13 through FIG. 15, a projecting part 61 (projection) is provided on the surface to the Z2 side of the overhang part 41 projecting further to the X1 side than the edge part to the X1 side of the overhang part 41. The projecting part 61 is biased to the X1 side by a compression spring 62.

In particular, on the surface to the Z2 side of the overhang part 41 is formed a spring housing groove 65 extending in the X direction. The spring housing groove 65 houses the compressing spring 62. The overhang part 41 has provided a guide shaft 63 interposing the spring housing groove 65 to the Y1 side and the Y2 side.

The projecting part 61 has a guide hole 61a that fits the guide shaft 63 formed therein. The guide hole 61a is a long hole extending in the X direction. The projecting part 61 is movable in the X direction, sliding along the guide shaft 63. On the edge part to the Z2 side of the guide shaft 63, a retaining ring 63a is attached so that the projecting part 61 does not drop off of the guide shaft 63.

A cutout portion 61b is formed in the edge part to the X2 side of the projecting part 61. The cutout portion 61b houses the edge part on the X1 side of the compression spring 62 The cutout portion 61b has provided a spring insertion part 61c that stretches along the X2 side. The spring insertion part 61c has the compression spring 62 inserted therein. The edge part of the compression spring 62 to the X2 side is attached to the chassis frame 11a.

Here, when the print head 30 is in a printing position, the projecting part 61 is attached to the side wall to the X2 side of the print head 30, and moves to the X2 side with the biasing force of the compression spring 62 (see FIG. 16). Thus an obstructing part 60 is formed by the overhang part 61 blocking the gap between the print head 30 and the overhang part 41.

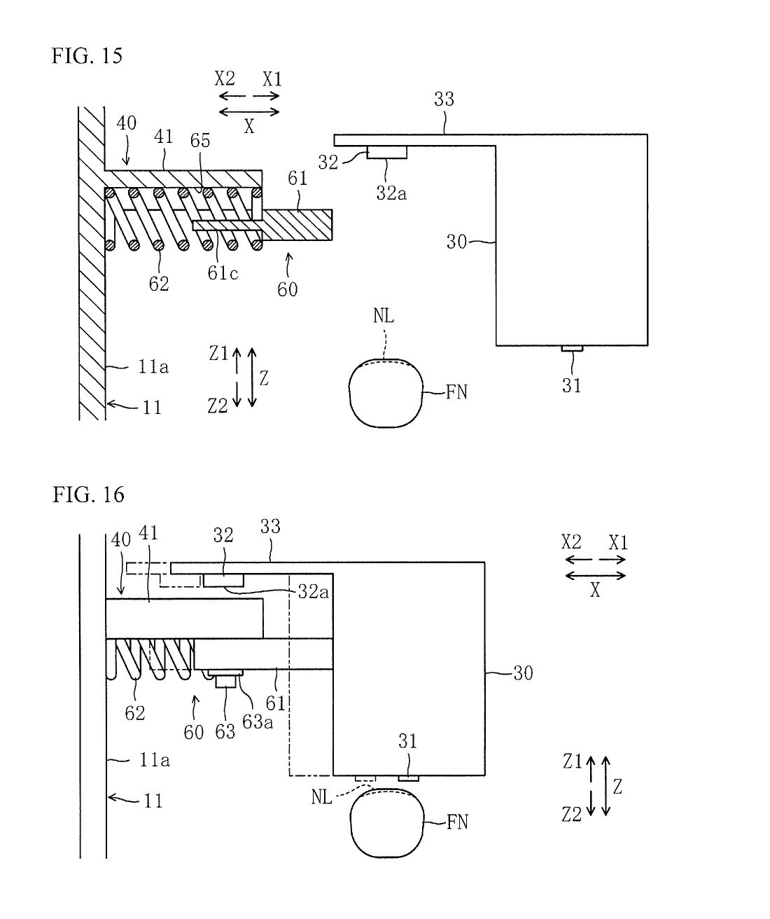

As illustrated in FIG. 15, when the print head 30 is in an imaging position, the camera unit 32, the overhang part 41, and the projecting part 61 do not overlap in a planar view, and the light receiving surface 32a of the camera unit 32 is exposed. Thus it is possible to image the nail part NL using the camera unit 32.

Meanwhile, as illustrated in FIG. 16, when the print head 30 is in a printing position, the camera unit 32 and the overhang part 41 overlap in a planar view, and the light receiving surface 32a of the camera unit 32 is covered by the overhang part 41. Further, the projecting part 61 is in contact with the side wall to the X2 side of the print head 30, blocking the gap. Thus, ink scattered in a mist form can be prevented from entering through the gap and adhering to the light receiving surface 32a of the camera unit 32 using the projecting part 41.

### Example 5

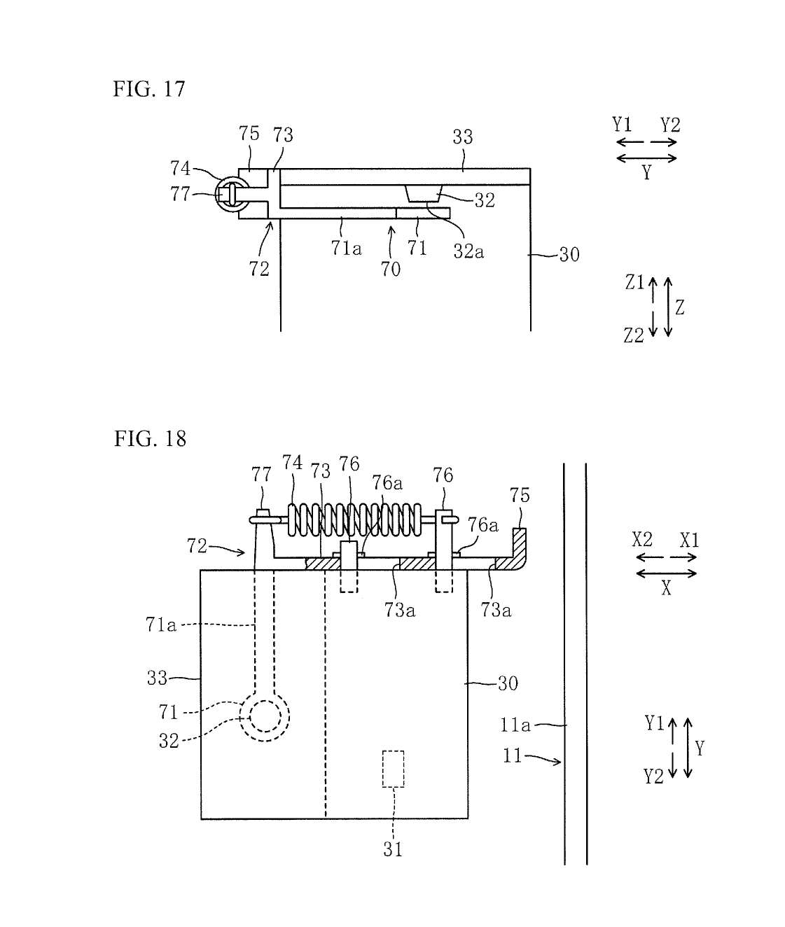

FIG. 17 is a profile drawing illustrating a configuration of a print head according to one or more embodiments of the present invention, and FIG. 18 is a planar drawing when a print head is in a printing position. Below the same reference numerals will be added for the same parts as the aforementioned example 1, and only the points of difference will be described.

As illustrated in FIG. 17 and FIG. 18, the chassis frame 11a of the chassis part 11 is provided further to the X1 side than the print head 30. A camera protection part 70 is installed on the print head 30, and has a shielding part 71 (shield) for covering the light receiving surface 32a of the camera unit 32 and a switching part 72 (switch) for switching between positions of the shielding part 71.

The shielding part 71 is composed of a plate shaped member that covers the light receiving surface 32a of the camera unit 32 on the print head 30 in a printing position. The shielding part 71 has provided an arm part 71a extending to the Y1 side.

The switching part 72 switches the position of the shielding part 71 between a shielded position covering the light receiving surface 32a of the camera unit 32 and an exposed position exposing the light receiving surface 32a of the camera unit 32. In particular, the switching part 72 has a slide part 73 (slider) for allowing the shielding part 71 to slide between the shielded position and the exposed position, and a tension spring 74 for positioning the shielding part 71 in the shielded position by biasing the slide part 73 to the X1 side.

The edge part of the slide part 73 to the X2 side is connected to the arm part 71a. Thus by moving the slide part 73 in the X direction, the shielding part 71 moves in the X direction via the arm part 71a. A contact part 75 that contacts the chassis frame 11a is provided on the edge part of the slide part 73 to the X1 side.

Guide shafts 76 are attached to the side wall of the print head 30 on the Y1 side. The two guide shafts 76 are disposed in the X direction with a gap there between. The length of the guide shaft 76 on the X1 side is longer than the length of the guide shaft 76 on the X2 side. Guide holes 73a to house the guide shafts 76 are formed in the slide part 73. The slide part 73 is formed with long holes extending in the X direction. The slide part 73 is movable in the X direction sliding along the guide shafts 76. The guide shafts 76 have attached a retaining ring 76a so that the slide part 73 does not drop off the guide shafts 76.

A spring hook part 77 extending in the Y1 direction is provided on the edge part slide part 73 on the X2 side. The tension spring 74 is attached over the guide shaft 76 on the X1 side and the spring hook part 77. Thus, the slide part 73 is biased to the X1 side by the tension spring 74, positioning the shielding part 71 in the shielding position. At this time the contact part 75 projects further to the X1 side than the print head 30.

When the print head 30 is in a printing position, the slide part 73 is biased to the X1 side by the tension spring 74, the camera unit 32 and the shielding part 71 overlap in a planar view, and the light receiving surface 32a of the camera unit 32 is covered by the shielding part 71. Thus, ink scattered in a mist form can be prevented from adhering to the light receiving surface 32a of the camera unit 32.

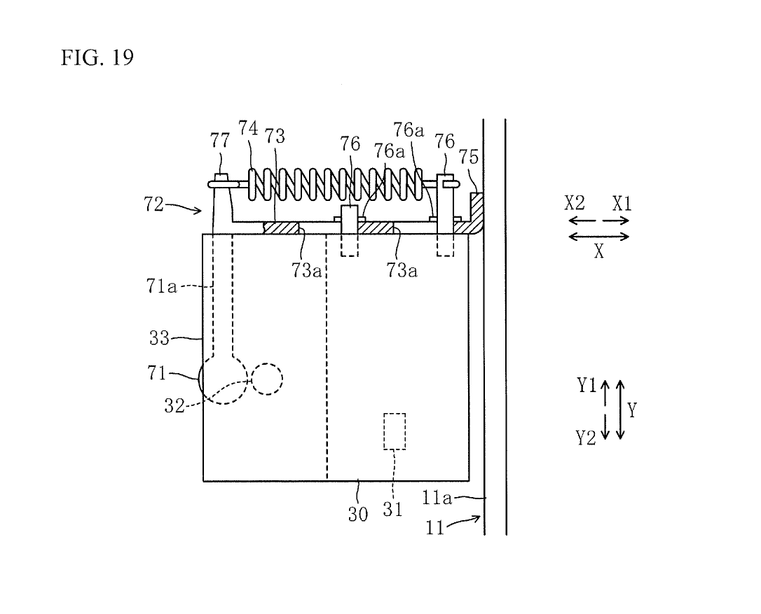

Meanwhile, as illustrated in FIG. 19, when the print head 30 is in an imaging position, the contact part 75 on the slide part 73 contacts the chassis frame 11a, and the slide part 73 slides to the X2 side with the biasing force of the tension spring 74. Because the shielding part 71 also slides to the X2 side with the movement of the slide part 73, the camera unit 32 and the shielding part 71 do not overlap in a planar view, and the light receiving surface 32a of the camera unit 32 is exposed. Thus it is possible to image the nail part NL using the camera unit 32.

### Example 6

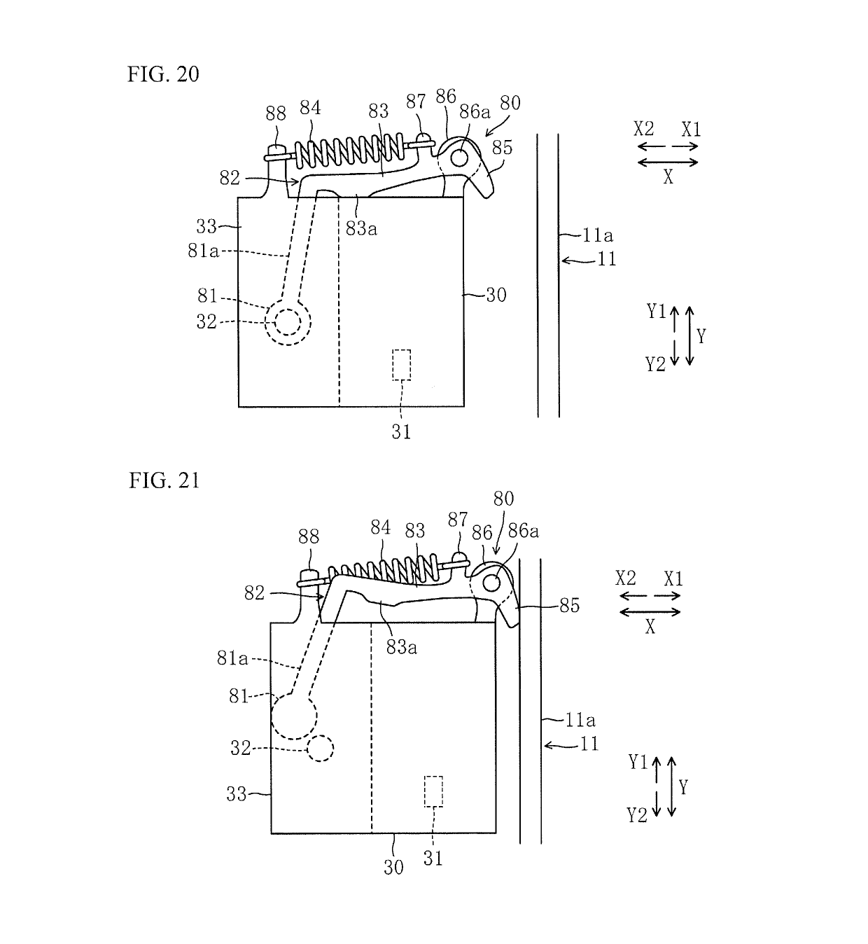

FIG. 20 is a planar drawing when a print head according to one or more embodiments of the present invention is in a printing position. Below the same reference numerals will be added for the same parts as the aforementioned example 5, and only the points of difference will be described.

As illustrated in FIG. 20, the chassis frame 11a of the chassis part 11 is provided further to the X1 side than the print head 30. A camera protection part 80 is installed on the print head 30, and has a shielding part 81 for covering the light receiving surface 32a of the camera unit 32 and a switching part 82 for switching between the positions of the shielding part 81.

The shielding part 81 is composed of a plate shaped member that covers the light receiving surface 32a of the camera unit 32 on the print head 30 in a printing position. The shielding part 81 has provided an arm part 81a extending to the Y1 side.

The switching part 82 switches the position of the shielding part 81 between a shielded position covering the light receiving surface 32a of the camera unit 32 and an exposed position exposing the light receiving surface 32a of the camera unit 32. In particular, the switching part 82 has a rotating part 83 (rotator) for rotating the shielding part 81 between the shielded position and the exposed position, and a tension spring 84 for biasing the rotating part 83 to position the shielding part 81 in the shielded position.

The edge part of the rotating part 83 to the X2 side is connected to the arm part 81a. The edge part of the rotating part 83 to the X1 side is controlled so that it can rotate centered on a central shaft 86a extending in the Z direction. The central shaft 86a is attached to a shaft retention part 86 overhanging to the Y1 side from the side wall of the print head 30 on the Y1 side. A contact part 85 that projects further to the X1 side than the print head 30 is provided on the edge part of the rotating part 83 to the X1 side. The edge part of the contact part 85 extends in to the Y2 side in addition to projecting to the X1 side.

A spring hook part 87 extending in the Y1 direction is provided on the edge part of the rotating part 83 on the X1 side. A spring hook part 88 extending in the Y1 direction is provided on the edge of the camera attachment part 33 on the Y1 side. A tension spring 84 is attached across the spring hook part 87 on the rotating part 83 and the spring hook part 88 on the camera attachment part 33.

A stopper part 83a projecting in the Y2 direction is provided on the edge part of the rotating part 83 on the X2 side. The rotation of the rotating part 83 is limited and the shielding part 81 is positioned in the shielding position by the stopper part 83a contacting the side wall of the print head 30 on the Y1 side.

When the print head 30 is in a printing position, the rotation part 84 is biased to a position in which the camera unit 32 and the shielding part 81 overlap in a planar view, and the light receiving surface 32a of the camera unit 32 is covered by the shielding part 81. Thus, ink scattered in a mist form can be prevented from adhering to the light receiving surface 32a of the camera unit 32.

Meanwhile, as illustrated in FIG. 21, when the print head 30 is in an imaging position, the contact part 85 of the rotating part 83 contacts the chassis frame 11a, and the rotating part 83 rotates centered around the central shaft 86a with the biasing force of the tension spring 84. Because the shielding part 81 moves to the X2 side with the rotation of the rotating part 83, the camera unit 32 and the shielding part 81 do not overlap in a planar view, and the light receiving surface 32a of the camera unit 32 is exposed. Thus it is possible to image the nail part NL using the camera unit 32.

### Example 7

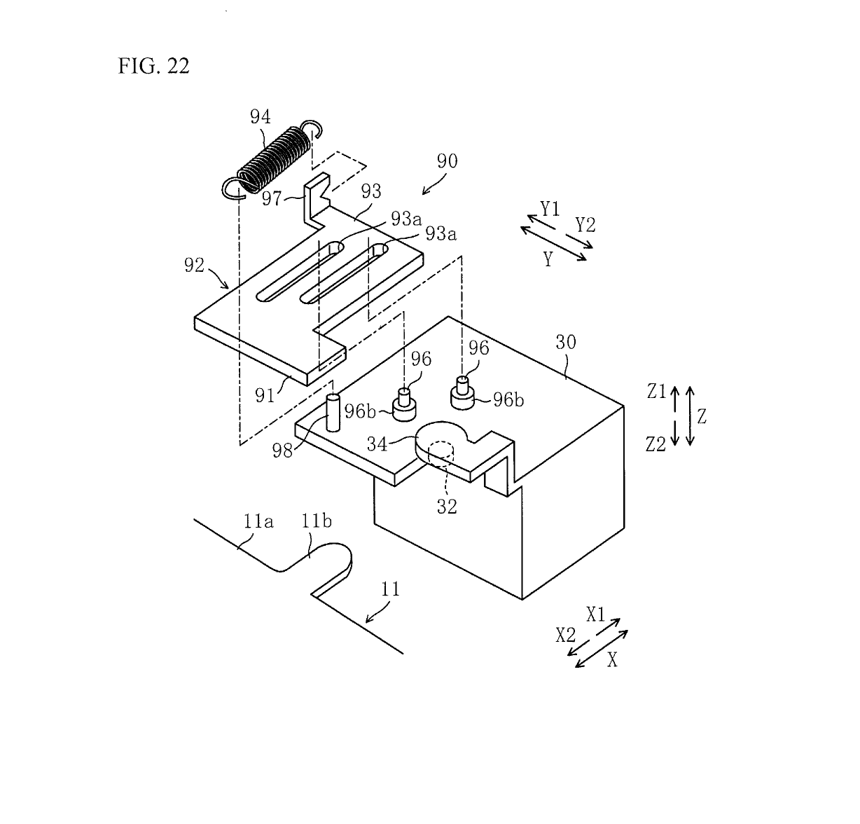

FIG. 22 is an exploded perspective drawing illustrating a configuration of a camera protection part according to one or more embodiments of the present invention. Below the same reference numerals will be added for the same parts as the aforementioned example 5, and only the points of difference will be described.

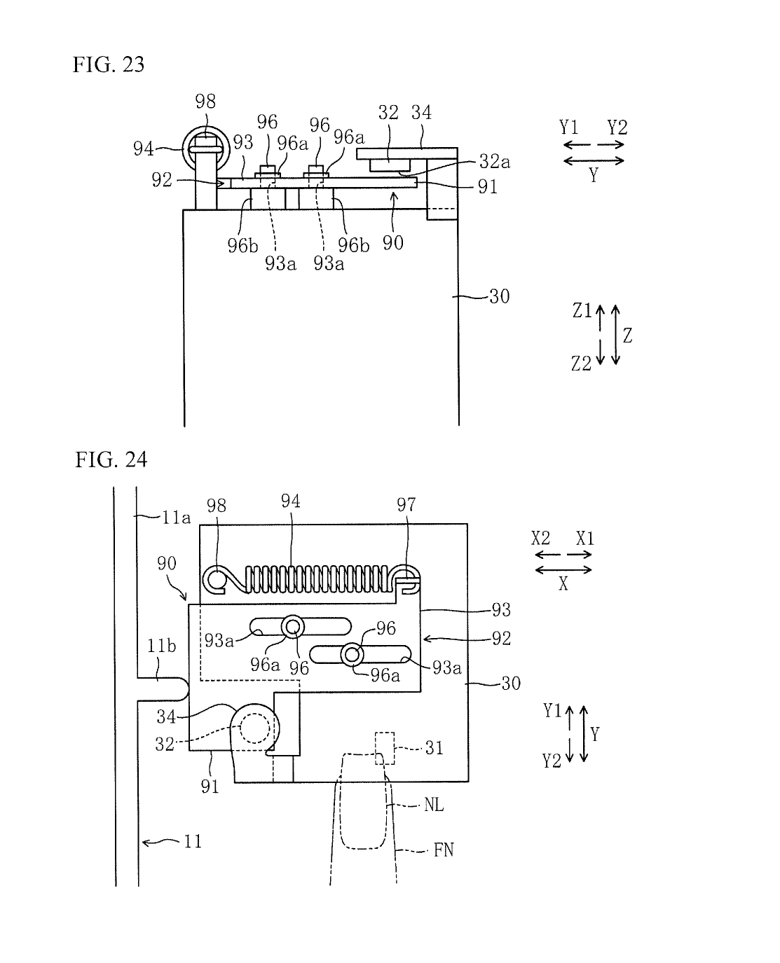

As illustrated in FIG. 22 through FIG. 24, the chassis frame 11a of the chassis part 11 is provided further to the X1 side than the print head 30. The chassis frame 11a has provided an extruding part 11b projecting to the X1 side.

The print head 30 has provided a camera attachment part 34 overhanging to the X2 side after it extends from the edge part along the Z1 side from the Z1 side. The camera unit 32 is attached to the surface on the Z2 side of the camera attachment part 34.

A camera protection part 90 is installed on the print head 30, and has a shielding part 91 for covering the light receiving surface 32a of the camera unit 32 and a switching part 92 for switching between the positions of the shielding part 91.

The shielding part 91 is composed of a plate shaped member that covers the light receiving surface 32a of the camera unit 32 on the print head 30 in a printing position.

The switching part 92 switches the position of the shielding part 91 between a shielded position covering the light receiving surface 32a of the camera unit 32 and an exposed position exposing the light receiving surface 32a of the camera unit 32. In particular, the switching part 92 has a slide part 93 for causing the shielding part 91 to slide between the shielded position and the exposed position, and a tension spring 94 for positioning the shielding part 91 in the exposed position by biasing the slide part 93 to the X2 side.

The shielding part 91 is a single body formed on the edge part of the slide part 93 on the X2 side. Thus when the slide part 93 moves in the X direction, the shielding part 91 moves in the X direction.

Guide shafts 96 are attached to the surface of the print head 30 on the Z1 side. The two guide shafts 96 are disposed in the X direction with a gap there between. The guide shaft 96 on the X1 side is disposed further to the Y2 side than the guide shaft 96 on the X2 side.

Guide holes 93a to house the guide shafts 96 are formed in the slide part 93. The guide holes 93a are long holes extending in the X direction. The slide part 93 is movable in the X direction sliding along the guide shafts 96. A retaining ring 96a is attached on the edge part of guide shafts 96 on the Z1 side so that the slide part 93 does not drop off the guide shafts 96. The guide shafts 96 house a spacer 96b, and a gap the thickness the spacer 96b is provided between the slide part 93 and the print head 30.

A spring hook part 97 extending to the Z1 side is provided on the edge part of the slide part 93 on the X1 side and Y1 side. A spring hook part 98 extending to the Z1 side is provided on the surface of the print head 30 on the Z1 side. The tension spring 94 is attached across the spring hook part 97 on the slide part 93, and the spring hook part 98 on the print head 30. Thus, the slide part 93 is biased to the X2 side by the tension spring 94, positioning the shielding part 91 in the exposed position. At this time the edge part of the slide part 93 on the X2 side projects farther to the X2 side than the print head 30.

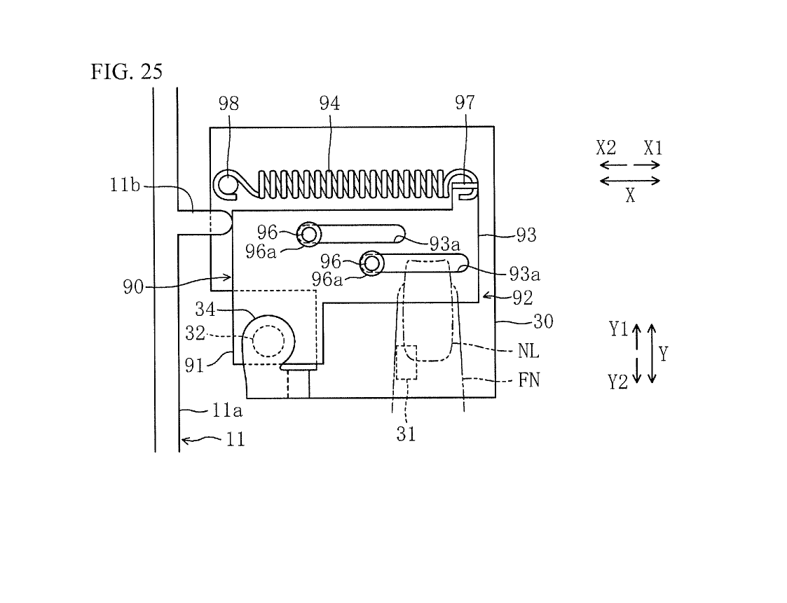

As illustrated in FIG. 24, when the print head 30 is in a printing position, the edge part of the slide part 93 on the X2 side contacts the extruding part 11b on the chassis frame 11a, and the slide part 93 slides to the X1 side with the biasing force of the tension spring 94. Because the shielding part 91 also moves to the X1 side with the movement of the slide part 93, the camera unit 32 and the shielding part 91 overlap in a planar view, and the light receiving surface 32a of the camera unit 32 is covered by the shielding part 91. The shielding part 91 can cover the light receiving surface 32a of the camera unit 32 while the print head 30 moves from the printing start position (the position indicated in FIG. 24) to the printing finish position (the position indicated in FIG. 25). Thus, ink scattered in a mist form can be prevented from adhering to the light receiving surface 32a of the camera unit 32.

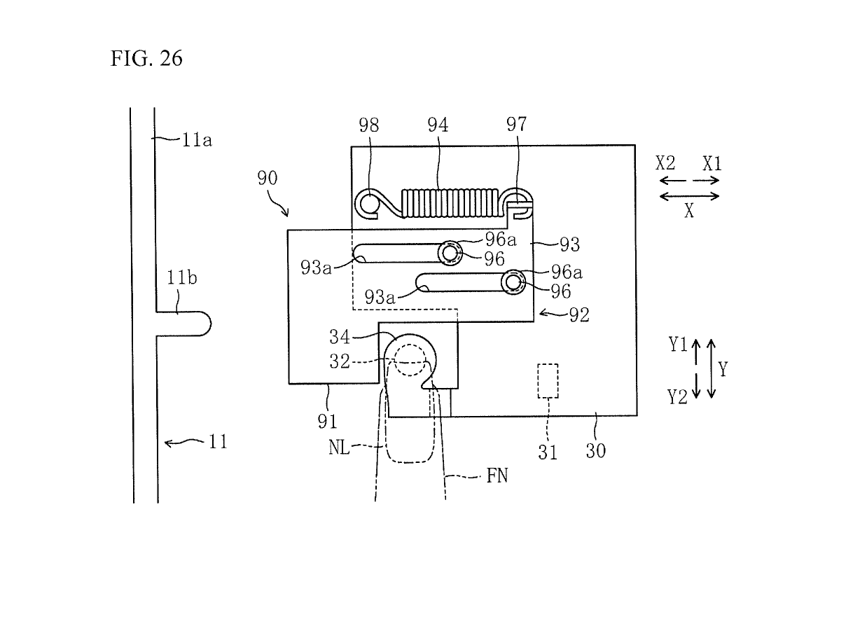

Meanwhile, as illustrated in FIG. 26, when the print head 30 is in an imaging position, with the separation of the edge part of the slide part 93 on the X2 side from the chassis frame 11a, the slide part 93 slides to the X2 side through the biasing force of the tension spring 94. Because the shielding part 91 also moves to the X2 side with the movement of the slide art 93, the camera unit 32 and the shielding part 91 do not overlap in a planar view, and the light receiving surface 32a of the camera unit 32 is exposed. Thus it is possible to image the nail part NL using the camera unit 32.

As described above, an aspect of the present invention is a printer comprising a print head for printing by discharging ink on a printing body while moving in at least a first direction. The printer further comprises a camera unit for imaging the printing body and a camera protection part for covering the light receiving surface of the camera unit during ink discharge by the print head.

In this aspect, ink scattered in a mist form is prevented from adhering to the light receiving surface of the camera unit by the camera protection part during ink discharge by the print head.

Also, in the printer in the above aspect, the print head may be configured so as to repeatedly move in the first direction while it is sent in steps in a second direction orthogonal to the first direction.

In this aspect, the print head is able to repeatedly move in the first direction while it is sent in steps in a second direction, with the light receiving surface of the camera unit always being covered by the camera protection part during ink discharge by the print head.

Also, in the printer in the above aspect, a chassis part may be provided containing the print head, and the camera protection part may have an overhang part overhanging from the chassis part to cover the light receiving surface of the camera unit.

In this aspect, because the camera protection part is configured by causing an overhang part to protrude from the chassis part, ink scattered in a mist form can be prevented from adhering to the light receiving surface of the camera unit with a relatively simple configuration.

Also, in the printer in the above aspect, there may be provided an obstructing part blocking the gap between the print head and the overhang part during ink discharge by the print head.

In this aspect, because the gap between the print head and the overhang part is blocked by the obstructing part, ink scattered in a mist form can be prevented from entering through the gap and adhering to the light receiving surface of the camera unit.

Also, in the printer in the above aspect, the camera protection part may have a shielding part for covering the light receiving surface of the camera unit, and a switching part for switching between a shielded position covering the light receiving surface of the camera unit, and an exposed position exposing the light receiving surface of the camera unit.

In this aspect, whether the light receiving surface of the camera unit is covered or exposed can be switched using the switching part.

Also, in the printer in the above aspect, a chassis part containing the print head may be provided; the camera protection part may be installed on the print head, and may be configured to for the position of the shielding part to be switchable by contacting the chassis part with the movement of the print head.

In this aspect, for example, when the print head is caused to move in an imaging position, in which imaging of the printing body is performed by the camera unit, by causing the switching part to contact the chassis part, it may be such that the position of the shielding part is switched from the shielded position to the exposed position. Thus, the light receiving surface of the camera unit may be caused to be shielded or exposed in connection with the movement of the print head.

Also, in the printer in the above aspect, the switching part may have a slide part for allowing the shielding part to slide between the shielded position and the exposed position.

In this aspect, the position of the shielding part may be switched just by causing the slide part to slide.

Also, in the printer in the above aspect, the switching part may have a rotating part for rotating the shielding part in between the shielded position and the exposed position.

In this aspect the position of the shielding part may be switched just by causing the rotating part to rotate.

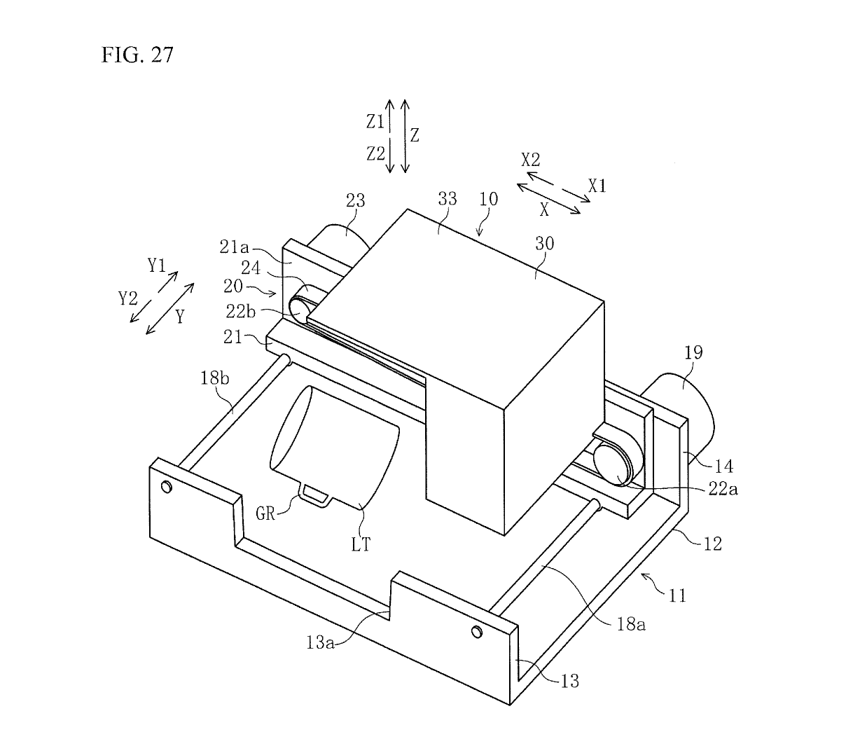

Next, an example will be described where the ejection device in accordance with one or more embodiments of the present invention is a printer that can print on a stereoscopic structure having a three-dimensional shape, for example, an object created by a 3D printer, a cup, a figure, or a saddle. FIG. 27 is a drawing illustrating a simplified configuration of the primary part of a printer according to one or more embodiments of the present invention. Here the description will use and example wherein the target object with a three-dimensional shape is a cup with a handle.

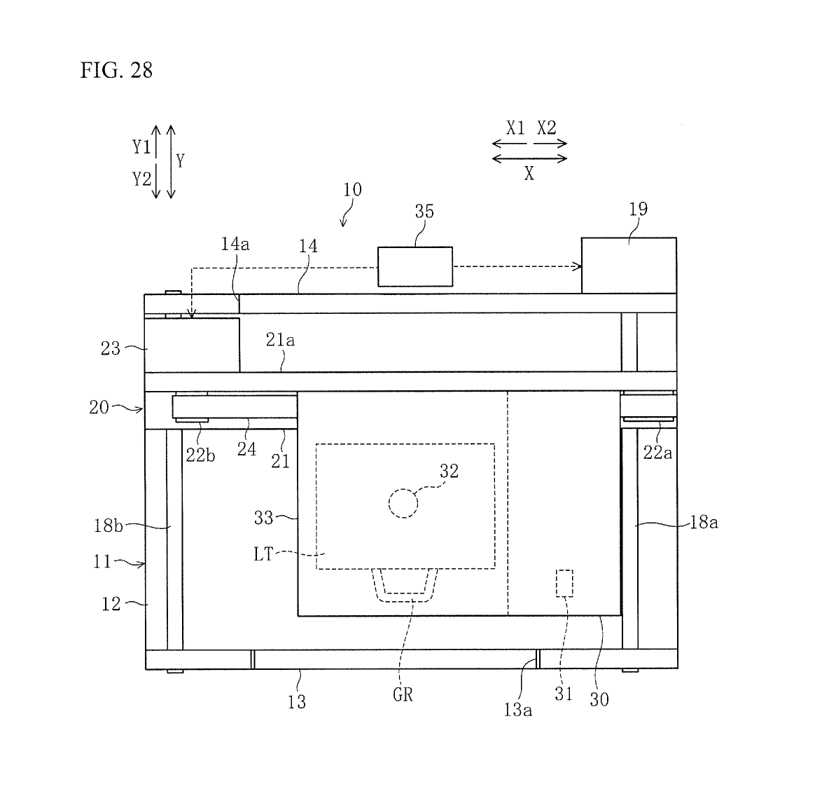

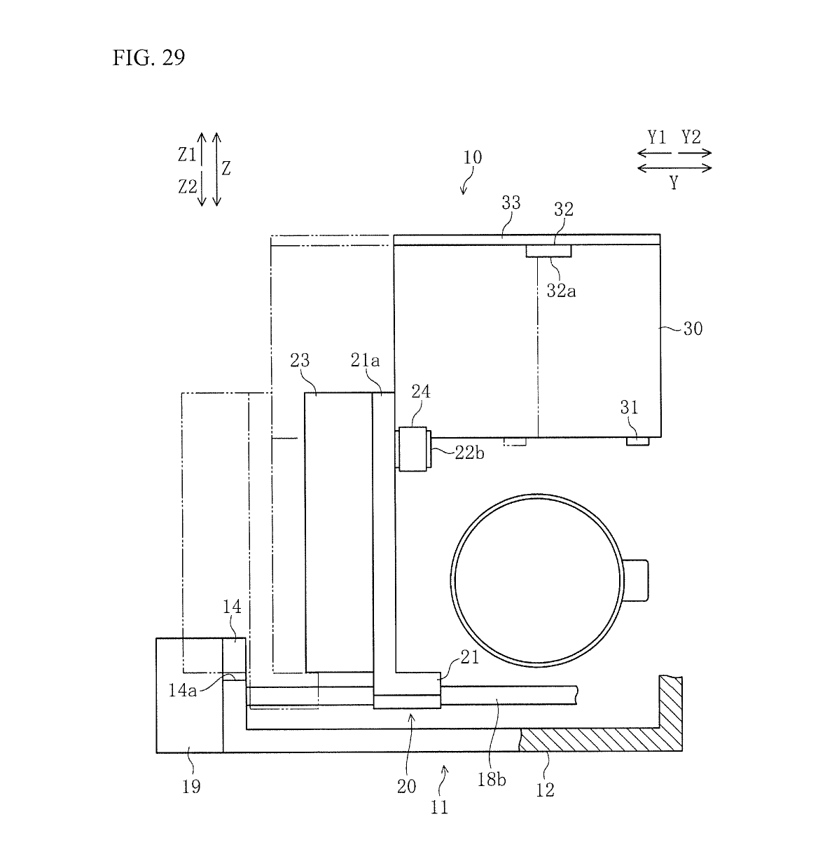

As illustrated in FIG. 27 through FIG. 29, the printer 10 comprises a chassis part 11 in which to dispose the side surface LT of a cup as a printing body, and a scanning part 20 with a print head 30 for printing on the side surface LT of the cup disposed in a predetermined position. The basic component configuration of the printer 10 illustrated in FIG. 27 through FIG. 29 is similar to the nail printer illustrated in FIG. 1 through FIG. 3.

As illustrated in FIG. 27, an open section 13a through which a target object can be inserted is formed in an approximately central position in the X direction in the first side wall 13 of the printer 10 according to one or more embodiments of the present invention. A finger fixing mechanism 15, a fixed frame 16, and a bias spring 17 for fixing the finger, as illustrated in FIG. 1, are not illustrated in FIG. 27, but arbitrary fixing mechanisms, such as, for example, an arm, a clamp, or a base to support the target object may be provided.

The configurations of the scanning part 20 and print head 30 are similar to the example of the printer 10 illustrated in FIG. 1, but the size of these components may differ according to the size of the target object.

As already described, the camera unit 32 may be switched between a printing position wherein the nozzle part 31 prints on the side surface LT of the cup, and an imaging position wherein the light receiving surface 32a of the camera unit 32 images the side surface LT by moving the print head 30 in the X direction and the Y direction.

In the controller 35, for example, a region of the side surface LT, that is, a region in which printing will be performed, is identified based on the captured image. The controller 35 also controls the operation of the print head 30 so as to print a predetermined design on the side surface LT.

Also, in the present example, a camera protection part 40 is provided to prevent ink scattered in a mist form from adhering to the light receiving surface 32a of the camera unit 32.

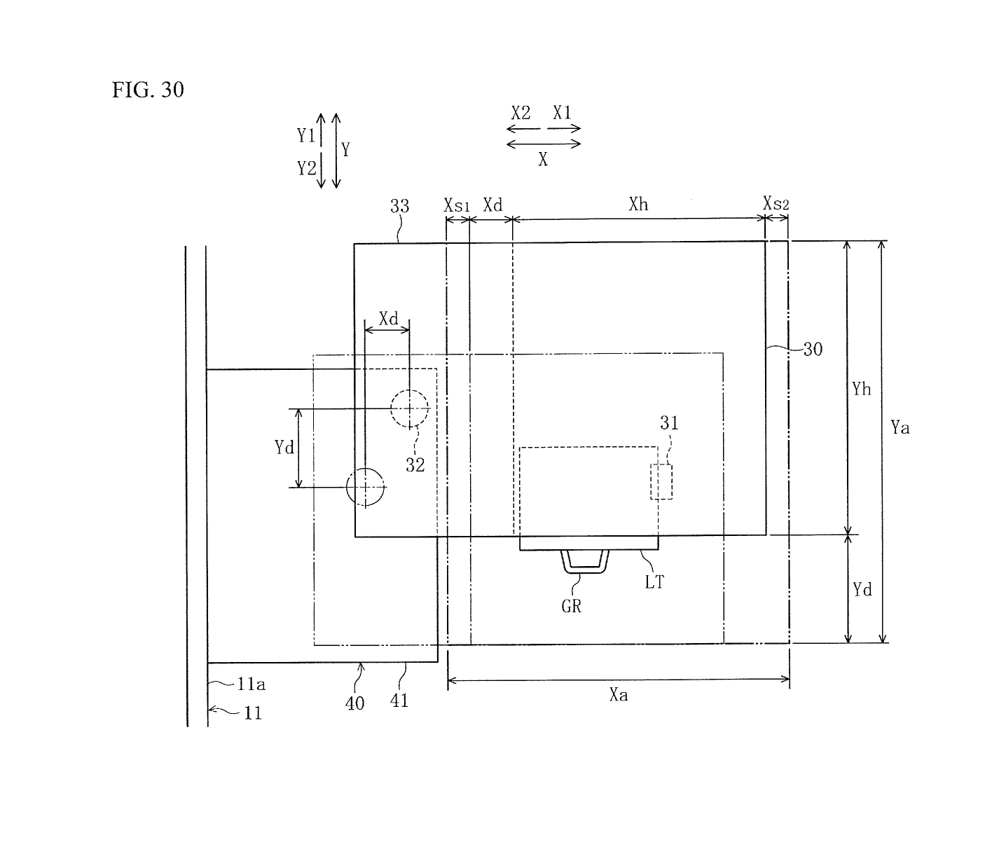

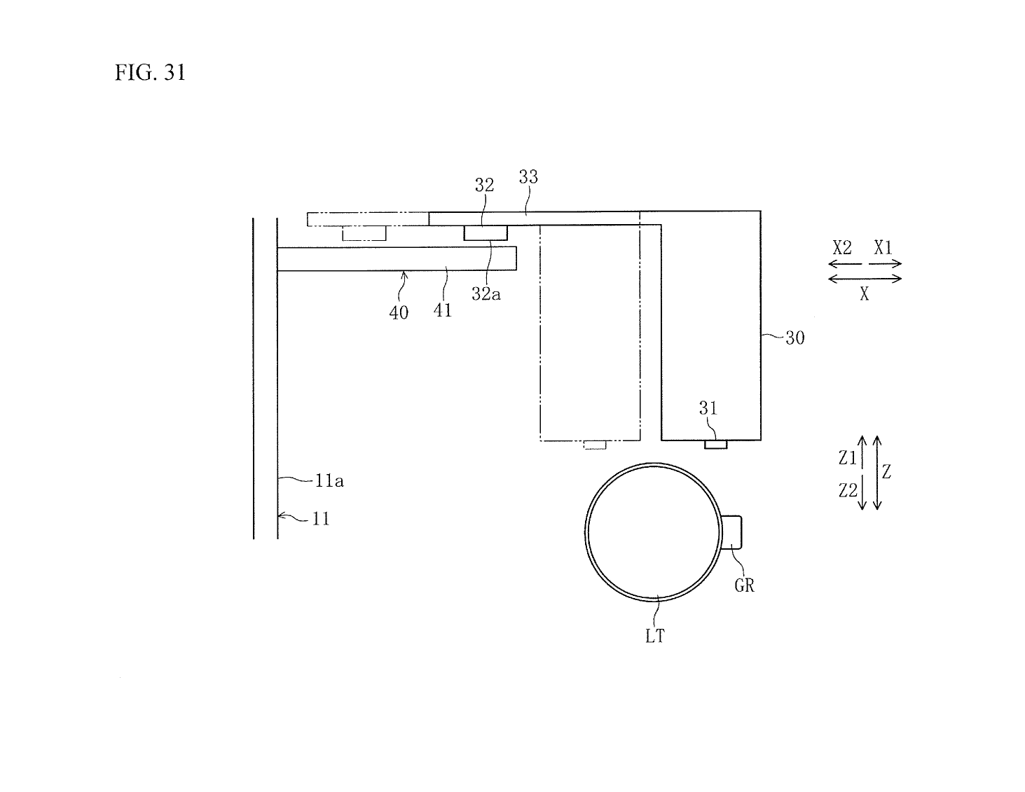

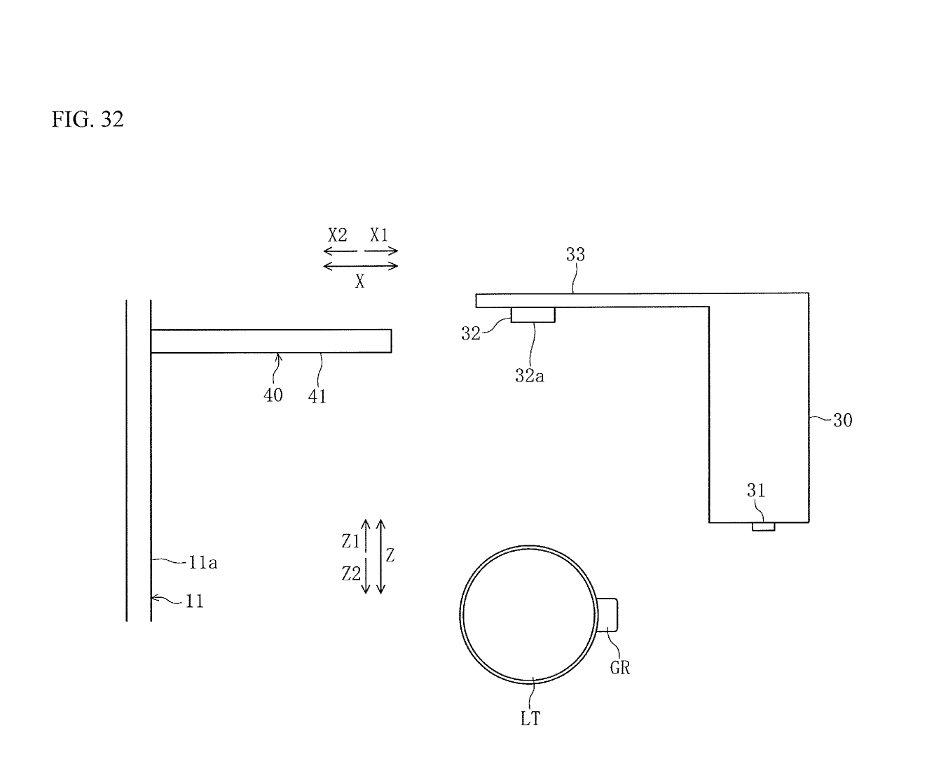

As illustrated in FIG. 30 and FIG. 31, a chassis frame 11a of the chassis part 11 is provided further on the X2 side than the print head 30. FIG. 30 and FIG. 31 correspond to FIG. 4 and FIG. 5, which described an example of a nail printer. As illustrated in FIG. 30 and FIG. 31, the chassis frame 11a has provided an overhang part 41 overhanging from the side wall on the X2 side to the X1 side; the overhang part 41 protrudes to a position that covers the light receiving surface 32a of the camera unit 32 on the print head 30 in a printing position.

In order to avoid interference with the print head 30, the overhang part 41 is disposed outside the movement range of the print head 30. In particular, the movement range of the print head 30 is a range set as Xa×Ya, where Xa is the length in the X direction and Ya is the length in the Y direction (the region enclosed in an imaginary line in FIG. 30).

The length in the X direction Xa is calculated using the sum of the length of the print head 30 in the X direction Xh, the stroke of the acceleration/deceleration area of the print head 30 in the X direction Xs1, Xs2, and the movement distance Xd in which the print head 30 moves in the X direction when printing on the side surface LT.

As already described, the stroke of the acceleration/deceleration area Xs1, Xs2 is the distance necessary for the print head 30 moving rapidly in the X direction to reach a constant speed. The movement distance Xd of the print head in the X direction is the distance for when the nozzle part 31 of the print head 30, indicated with a solid line in FIG. 30, moves to the position of the nozzle part 31 indicated with an imaginary line in FIG. 30.

In particular, the edge part to the X1 side and Y1 side of the side surface LT is the printing start position for the print head 30, and the edge part to the X2 side and Y2 side of the side surface LT is the printing finish position for the print head 30. When printing on the side surface LT, the print head 30 moves from the printing start position to the printing finish position to thereby determine the movement distance X_{d} of the print head 30 in the X direction.

The length in the Y direction Ya is calculated using the sum of the length of the print head 30 in the Y direction Yh and the movement distance Yd in which the print head 30 moves in the Y direction when printing on the side surface LT.

The movement distance Y_{d} of the print head 30 in the Y direction is the distance for when the nozzle part 31 of the print head 30, indicated with a solid line in FIG. 30, moves to the position of the nozzle part 31 indicated with an imaginary line in FIG. 30. When printing on the site surface LT, the print head 30 moves from the printing start position to the printing finish position to thereby determine the movement distance Yd of the print head 30 in the Y direction.

The overhang part 41 is set at a size at which it is possible for it to cover the camera unit 32 while the print head 30 discharges ink as it moves from the printing start position to the printing finish position in the X direction and the Y direction. In particular, because the camera unit 32 moves only a distance Xd in the X direction with the print head 30, and moves only a distance Yd in the Y direction, it is set at a size at which it is possible to cover at least this movement range.

When the print head 30 is in a printing position, the camera unit 32 and the overhang part 41 overlap in a planar view, and the light receiving surface 32a of the camera unit 32 is covered by the overhang part 41. Thus ink scattered in a mist form can be prevented from adhering to the light receiving surface 32a of the camera unit 32.

Meanwhile, as illustrated in FIG. 31, when the print head 30 is in an imaging position, the camera unit 32 and the overhang part 41 do not overlap in a planar view, and the light receiving surface 32a of the camera unit 32 is exposed. Thus it is possible to image the side surface LT using the camera unit 32.

Using a configuration of this sort, it is possible to expose the light receiving surface 32a of the camera unit 32 in an imaging position, making imaging of the side surface LT possible, as well as to cover the light receiving surface 32a of the camera unit 32 in a printing position with overhang part 41, protecting the camera unit 32, just by moving the print head 30 between an imaging position and a printing position.

Above was described an example wherein it is possible for a printer 10 according to one or more embodiments of the present invention to protect the light receiving surface of a camera unit 32 when printing on the side surface LT of a cup. The present invention is not limited to these examples, and may be applied to a printer printing any stereoscopic structure having a predetermined size and shape, such as, for example, a figure, a bicycle seat, human skin besides fingernails, a stationery product, a household furnishing, or an electronic device.

In one or more embodiments of the present invention, the print head 11 included in the ink mechanism 10 in the printer may discharge liquid droplets of cosmetic goods or of a fluid incorporating drugs used on skin in the liquid instead of ink. Thus, for example, cosmetic goods or medication can be applied with high precision to skin on the human body.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### INDUSTRIAL APPLICABILITY

As was described above, because the present invention can obtain a highly practical effect of preventing ink scattered in a mist form from adhering to a light receiving surface of a camera unit, it is extremely useful having high industrial applicability.

### DESCRIPTION OF THE REFERENCE NUMERALS

10 Printer (Ejection device)
11a Chassis Frame (Chassis Part)
30 Print Head
32 Camera unit
32a Light Receiving Surface
40, 70, 80, 90 Camera Protection Part
41 Overhang part
50, 55, 60 Obstructing Part
71, 81, 91 Shielding Part
72, 82, 92 Switching Part
73, 93 Slide Part
83 Rotating Part
NL Nail Part (Printing Body)

What is claimed is:

1. An ejection device, comprising:
a discharger that discharges liquid droplets on an object while moving in at least a first direction;
a camera that images the object; and
a camera protector that covers a light receiving surface of the camera when the discharger discharges the liquid droplets.

2. The ejection device according to claim 1, wherein the discharger repeatedly moves in the first direction and performs step feed in a second direction perpendicular to the first direction.

3. The ejection device according to claim 1, further comprising:
a chassis that comprises the discharger, wherein
the camera protector has an overhang that overhangs from the chassis to cover the light receiving surface.

4. The ejection device according to claim 3, further comprising:
an obstructing part that blocks a gap between the discharger and the overhang when the discharger discharges the liquid droplets.

5. The ejection device according to claim 1, wherein the camera protector comprises:
a shield that covers the light receiving surface; and
a switch that switches positions of the shield between:
a shielded position where the light receiving surface is covered, and
an exposed position where the light receiving surface is not covered.

6. The ejection device according to claim 5, further comprising:
a chassis that comprises the discharger, wherein
the camera protector is provided on the discharger, and
the switch switches the positions of the shield by contacting the chassis with the movement of the discharger.

7. The ejection device according to claim 5, wherein the switch comprises a slider that allows the shield to slide between the shielded position and the exposed position.

8. The ejection device according to claim 5, wherein the switch comprises a rotator that allows the shield to rotate between the shielded position and the exposed position.

9. The ejection device according to claim 3, wherein the overhang is provided outside a movement range of the discharger.

10. The ejection device according to claim 9, wherein the overhang has an area greater than or equal to a product of a first movement distance and a second movement distance, wherein the first movement distance is a movable distance of the discharger in the first direction, and the second movement distance is a movable distance of the discharger in a second direction perpendicular to the first direction.

11. The ejection device according to claim 4, wherein
the chassis further comprises an extending section that extends in a camera attachment for attaching the camera and that has a stepped part, and
the obstructing part is formed by the extending section.

12. The ejection device according to claim 4, wherein
the camera comprises a camera attachment that has a through-hole, and
the obstructing part is formed by an elastic member fitted in the through-hole.

13. The ejection device according to claim 12, wherein, when the discharger discharges the liquid droplets, the elastic member contacts the overhang and deforms to block the gap between the discharger and the overhang.

14. The ejection device according to claim 4, wherein
a spring and a projection are provided on the overhang, and
the gap between the discharger and the overhang is blocked by the projection contacting the chassis due to bias of the spring.

15. The ejection device according to claim 1, wherein the liquid droplets are cosmetics.

16. The ejection device according to claim 1, wherein the liquid droplets are medication.

17. The ejection device according to claim 1, further comprising a fixing mechanism that fixes the object.
